(19) United States
(12) Patent Application Publication
(10) Pub. No.: US 2026/0302612 A1
(43) Pub. Date: Oct. 1, 2026

(54) RADIO TRANSCEIVER, DISTRIBUTED PHASED ARRAY ANTENNA SYSTEM, DISTRIBUTED ELECTROMAGNETIC WAVE OBSERVATION DATA COLLECTION SYSTEM, AND DISTRIBUTED SYNTHETIC APERTURE RADAR SYSTEM

(71) Applicant: National Institute of Information and Communications Technology, Koganei-shi, Tokyo (JP)

(72) Inventors: Ryosuke ISOGAI, Tokyo (JP); Yozo SHOJI, Tokyo (JP)

(73) Assignee: National Institute of Information and Communications Technology, Koganei-shi, Tokyo (JP)

(21) Appl. No.: 18/996,432

(22) PCT Filed: Jun. 16, 2023
(86) PCT No.: PCT/JP2023/022433

§ 371 Date: Jan. 17, 2025

(30) Foreign Application Priority Data
Jul. 19, 2022 (JP) 2022-114731

(51) Int. Cl. H01Q 3/34; G01S 7/02; G01S 13/90; H04B 1/40

(52) U.S. Cl. CPC H01Q 3/34; G01S 7/02; G01S 13/90; H04B 1/40

(57) ABSTRACT

A radio transceiver 2 transmits and receives codes to and from other radio transceivers 2 via an antenna 27 for synchronization and acquires, using a space-time difference information acquisition unit 28, space-time difference information including both time difference information, which is a time error relative to a radio transceiver 2 serving as a reference, and spatial difference information, which is a spatial error relative to the radio transceiver 2 serving as the reference. Based on this space-time difference information, a phase shift adjustment unit 24 causes a phase shifter 221 of a transmission-reception module 22 to control a phase shift amount of a radio frequency signal emitted from a communication antenna 21 such that a space-time error is corrected, thereby suppressing degradation in beam quality due to the space-time error.

### TECHNICAL FIELD

The present invention relates to a radio transceiver capable of acquiring space-time difference information regarding the radio transceiver, a distributed phased array antenna system using a plurality of radio transceivers, a distributed electromagnetic wave observation data collection system using a plurality of radio transceivers, and a distributed synthetic aperture radar system using a plurality of radio transceivers.

### BACKGROUND ART

Array antennas including a plurality of small antennas forming an array include a phased array antenna in which each antenna element is connected to a phase shifter and beam formation is performed by controlling the relative phase shift amount between antennas. Beam control performed by phased array antennas has advantages over conventional mechanically driven scanning beam control, such as higher speed and controllability and reduced failure rate due to fewer moving portions. There are a wide variety of uses for phased array antennas, including adaptively directing the main lobe toward a specific party to improve the efficiency of data transfer and use as information-gathering radars.

There is a synthetic aperture radar (SAR) that allows relatively small aperture antennas to effectively synthesize a large aperture antenna by transmitting radio waves to the ground while moving and by receiving and synthesizing the reflected waves using a radar mounted on a flying object, such as an artificial satellite or aircraft. SARs are used for Earth observation and planetary exploration, for example, because SARs can operate in all weather conditions and capture high-resolution images of terrain and other features, regardless of whether it is day or night. There is also an SAR using a phased array (for example, a phased array type L-band synthetic aperture radar (PALSAR)), for example.

In the phased-array antennas described above and SARs based on the applications of the phased-array antennas, relative phase control between antenna elements is important to obtain desired beam characteristics through synthesis of the radio waves emitted by each antenna element. Thus, generally, a plurality of antenna elements and phase shifters are wired together individually, and the relative phase of the radio waves emitted from each antenna element is centrally controlled to obtain the desired beam characteristics.

In the phased-array antennas and SARs based on the applications of the phased-array antennas, there is a distributed antenna/distributed SAR technology in which each of the antenna elements constituting an array antenna has a reference signal generator and an amplifier and independently controls its own phase. In such a distributed antenna or a distributed SAR, the desired beam characteristics can be achieved by performing phase adjustment in accordance with the arrangement of each antenna element, as long as the arrangement state of each antenna element is kept stable. However, in a case where the arrangement state of each antenna element changes, autonomous control needs to be performed with consideration for the relative phase of the radio waves between the individual antenna elements.

For example, in a case where an artificial satellite is launched into a satellite orbit with the antenna panel folded and then the antenna panel is deployed, the ideal radiation surface shape cannot be achieved for the phased array antenna because of mechanical or thermal distortion, so that ideal characteristics cannot be achieved. A technique has been proposed to detect phase errors induced by such antenna shape distortion, for example, using optical techniques to obtain phase correction values necessary to compensate for these errors, and to perform real-time shape compensation (see, for example, PTL 1). In the phased array antenna described in this PTL 1, each antenna panel is divided into modules (units each including an antenna element, an amplifier, a phase shifter, and a controller). Thus, by downsizing the individual modules themselves and folding them one on top of the other, which makes it easy to stow the phased array antenna inside the payload fairing of a launch vehicle.

A distributed aperture system has also been proposed in which a plurality of small satellites is each equipped with an antenna element, and the plurality of small satellites maintains its positional relationship in coordination with each other or with the assistance of a control satellite to form a phased array antenna (see, for example, PTL 2). The distributed aperture system described in this PTL 2 employs a technique that uses electromagnetic coils to change the relative distance between each satellite to maintain a distance x and an angle y in order to maintain a constant relative position between the small satellites and between each small satellite and the control satellite.

### CITATION LIST

### Patent Literature

[PTL 1] Japanese U.S. Pat. No. 4,951,622

[PTL 2] Japanese U.S. Pat. No. 6,506,365

### SUMMARY OF INVENTION

### Technical Problem

However, in the phased array antenna described in PTL 1, the antenna modules that perform independent phase control are wired together and mounted on the same mobile unit (satellite). Thus, as the number of modules increases, the overall size of the phased array antenna becomes larger, making it difficult to stow the antenna in a narrow space. Furthermore, the phased array antenna described in PTL 1 does not allow the antenna modules to be rearranged freely. Thus, the phased array antenna described in PTL 1 does not provide flexibility to replace a failed antenna module with a normal antenna module for operation, or scalability to increase or decrease the number of antenna modules or to change the antenna module arrangement structure as needed.

In contrast, in the distributed aperture system described in PTL 2, the antenna elements are mounted on a plurality of respective mobile units (satellites), and form an array antenna as a whole. Thus, the distributed aperture system described in PTL 2 provides excellent flexibility to replace a failed mobile unit with a mobile unit having a normal antenna element for operation, and excellent scalability to increase or decrease the number of mobile units or to change the mobile unit arrangement structure as needed. However, in the distributed aperture system described in PTL 2, the individual mobile units need to maintain a certain positional relationship to each other to form an array, and the accuracy of positioning depends on the movement means of the mobile units and disturbances. Thus, the shift from the ideal arrangement due to misalignment can be a non-negligible error. In other words, if the ideal arrangement state of the antenna elements cannot be maintained, the quality of the beam emitted by the array antenna as a whole will be degraded. Note that this issue is not limited to cases where antenna elements are mounted on mobile units. This issue also applies to portable fixed distributed antennas, and the quality of the beam emitted by the array antenna as a whole is degraded due to misalignment caused when each antenna is installed. In the distributed aperture system described in PTL 2, since the independent small satellites are arrayed, high-precision time synchronization using a common clock cannot be achieved, as is the case with known phased array antennas. Thus, the quality of the beam emitted by the array antenna as a whole is degraded due to the time shift of each small satellite. In beamforming antennas, which can form reception beams with various directivities by synthesizing, through appropriate weighting, reception signals received by a plurality of antenna elements, the quality of beams formed is degraded in a case where there is a phase shift in the reception signals. Even in synthetic aperture radars, in which a synthetic aperture radar signal processing device is capable of generating a two-dimensional image by processing reception signals obtained by a plurality of antenna elements repeatedly transmitting and receiving a pulse while moving over an image acquisition area in an azimuth direction, the quality of the two-dimensional image is degraded in a case where there is a phase shift in transmission or reception signals.

Thus, the present invention aims to provide a radio transceiver capable of acquiring phase shift information that is usable as correction information for suppressing degradation in beam quality, a distributed phased array antenna system using a plurality of radio transceivers, a distributed electromagnetic wave observation data collection system using a plurality of radio transceivers, and a distributed synthetic aperture radar system using a plurality of radio transceivers.

### Solution to Problem

In order to solve the problems described above, a first radio transceiver is usable as an antenna element included in a phased array antenna system in which a plurality of the antenna elements is arranged in an array to obtain a desired directivity, and includes N (N is any natural number) communication antennas, a space-time difference information acquisition unit, a phase shift adjustment unit, and a reference oscillator that generates a reference frequency signal. The space-time difference information acquisition unit transmits and receives codes to and from another radio transceiver in both ways through wireless communication using an antenna for synchronization different from the communication antennas, measures time difference information and spatial difference information based on a time shift between the reference oscillators of the radio transceivers and a propagation delay time associated with the code transmission and reception, and acquires space-time difference information including the time difference information and the spatial difference information. The time difference information is a time error between the radio transceiver serving as a reference and the radio transceiver, and the spatial difference information is a spatial error between a current position of the radio transceiver and a proper position of the radio transceiver relative to the radio transceiver serving as the reference. The phase shift adjustment unit adjusts, based on the space-time difference information, a phase shift amount of radio waves radiated from the communication antennas to correct the time error, the spatial error, or both the time and spatial errors.

Furthermore, a distributed phased array antenna system according to the present invention constitutes the phased array antenna system that includes a plurality of the first radio transceivers and has a specific directivity obtained by superimposing radio waves radiated from the communication antennas of each radio transceiver.

Moreover, in order to solve the problems described above, a second radio transceiver is usable as an antenna element included in a beamforming antenna in which a plurality of the antenna elements is arranged in an array and that is capable of forming reception beams with various directivities by synthesizing reception signals, which are received by the respective antenna elements, through appropriate phase shift processing and appropriate weighting (amplitude amplification and attenuation) processing, and includes N (N is any natural number) communication antennas, a space-time difference information acquisition unit, N signal reception units corresponding to the respective communication antennas, a reception data transmission unit, and a reference oscillator that generates a reference frequency signal. The space-time difference information acquisition unit transmits and receives codes to and from another radio transceiver in both ways through wireless communication using an antenna for synchronization different from the communication antennas, measures time difference information and spatial difference information based on a time shift between the reference oscillators of the radio transceivers and a propagation delay time associated with the code transmission and reception, and acquires space-time difference information including the time difference information and the spatial difference information. The time difference information is a time error between the radio transceiver serving as a reference and the radio transceiver, and the spatial difference information is a current relative position of the radio transceiver to the radio transceiver serving as the reference. The reception data transmission unit transmits, outside the radio transceiver, reception data in which reception signals received by the signal reception units, the space-time difference information at reception timings of the reception signals, and unique information regarding the radio transceiver set to allow identification between the radio transceiver and the other radio transceiver are associated with each other.

Furthermore, a distributed electromagnetic wave observation data collection system according to the present invention includes a plurality of slave mobility devices that is obtained by mounting the second radio transceivers on mobile units, and a master mobility device that is obtained by mounting a data relay on a mobile unit, the data relay at least collecting reception data transmitted from the plurality of slave mobility devices and transferring the collected reception data collectively to a predetermined data collection center. The plurality of slave mobility devices and the master mobility device are arranged in an electromagnetic wave observation area that is set freely, only the master mobility device that has collected the reception data from each slave mobility device transfers the collected reception data as electromagnetic wave observation data to the data collection center.

Moreover, in order to solve the problems described above, a third radio transceiver is usable as an antenna element included in a synthetic aperture radar in which a plurality of the antenna elements is arranged in an array and that is capable of generating a two-dimensional image by causing a synthetic aperture radar signal processing device to process reception signals obtained by repeatedly transmitting and receiving a pulse while moving over an image acquisition area in an azimuth direction, and includes N (N is any natural number) communication antennas, N pulse transmission reception units corresponding to the respective communication antennas, a space-time difference information acquisition unit, a reception data transmission unit, and a reference oscillator that generates a reference frequency signal. The space-time difference information acquisition unit transmits and receives codes to and from another radio transceiver in both ways through wireless communication using an antenna for synchronization different from the communication antennas, measures time difference information and spatial difference information based on a time shift between the reference oscillators of the radio transceivers and a propagation delay time associated with the code transmission and reception, and acquires space-time difference information including the time difference information and the spatial difference information. The time difference information is a time error between the radio transceiver serving as a reference and the radio transceiver, and the spatial difference information is a current relative position of the radio transceiver to the radio transceiver serving as the reference. The reception data transmission unit transmits, as reception data, reflected signals received by the pulse transmission reception units, the space-time difference information acquired by the space-time difference information acquisition unit, and unique information regarding the radio transceiver set to allow identification between the radio transceiver and the other radio transceiver to the synthetic aperture radar signal processing device.

Furthermore, a distributed synthetic aperture radar system according to the present invention includes a master synthetic aperture radar device that is obtained by mounting the third radio transceiver on a mobile unit and that transmits a pulse signal to the image acquisition area and receives a reflected signal, M (M is any natural number) slave synthetic aperture radar devices that are obtained by mounting the radio transceivers according to Claim 5 on mobile units and that transmit pulse signals to the same image acquisition area as the master synthetic aperture radar device and receive reflected signals, and a synthetic aperture radar signal processing device that generates a two-dimensional image by processing reception data from the master synthetic aperture radar device and the slave synthetic aperture radar devices. The slave synthetic aperture radar devices acquire the space-time difference information using the master synthetic aperture radar device as the radio transceiver serving as a reference, and transmit pulse signals in synchronization with pulse transmission of the master synthetic aperture radar device by performing phase adjustment to correct the time errors based at least on the time difference information. The synthetic aperture radar signal processing device performs phase adjustment to correct, based at least on the spatial difference information in the space-time difference information, the spatial error regarding the reflected signals in the reception data from the master synthetic aperture radar device, the slave synthetic aperture radar devices, or both the master and slave synthetic aperture radar devices.

### Advantageous Effects of Invention

With the first to third radio transceivers according to the present invention, space-time difference information relative to another radio transceiver can be acquired. Thus, a distributed phased array antenna system using a plurality of the first radio transceivers can suppress degradation in beam quality by using the space-time difference information acquired by each radio transceiver as correction information. Moreover, a distributed electromagnetic wave observation data collection system using a plurality of the second radio transceivers can suppress degradation in beam quality by using the space-time difference information acquired by each radio transceiver as correction information. Moreover, a distributed synthetic aperture radar system using a plurality of the third radio transceivers can suppress the quality degradation of two-dimensional images by using the space-time difference information acquired by each radio transceiver as correction information.

### BRIEF DESCRIPTION OF DRAWINGS

FIG. 1(A) is a schematic configuration diagram of a distributed phased array antenna system according to a present embodiment. FIG. 1(B) is a schematic configuration diagram illustrating a first configuration example for a radio transceiver used in the distributed phased array antenna system.

FIG. 2(A) illustrates an image of a first example of radiation characteristics in a distributed phased array antenna system in which radio transceivers are linearly arranged and equally spaced to function as a linear array antenna.

FIG. 2(B) illustrates an image of a second example of radiation characteristics in the distributed phased array antenna system in which the radio transceivers are linearly arranged and equally spaced to function as a linear array antenna.

FIG. 3(A) illustrates an image of radiation characteristics for a case where there is not a time error in the reference oscillator of each radio transceiver used in a distributed phased array antenna system. FIG. 3(B) illustrates an image of radiation characteristics for a case where there is a time error in the reference oscillator of each radio transceiver used in the distributed phased array antenna system. FIG. 3(C) illustrates an image of radiation characteristics for a case where a time error included in the reference oscillator of each radio transceiver used in the distributed phased array antenna system is corrected on the basis of time difference information.

FIG. 4 is a diagram for describing a correction operation performed by each radio transceiver used in the distributed phased array antenna system to detect phase differences from each other to synchronize phases.

FIG. 5 is a schematic configuration diagram illustrating a second configuration example for a radio transceiver.

FIG. 6 is a schematic configuration diagram illustrating a third configuration example for a radio transceiver.

FIG. 7(A) illustrates an image of a distributed phased array antenna system in which radio transceivers mounted on a plurality of respective vehicles are used. FIG. 7(B) illustrates an image of a distributed phased array antenna system in which radio transceivers mounted on a plurality of respective unmanned aerial vehicles are used.

FIG. 8 is a schematic diagram of a distributed electromagnetic wave observation data collection system constituted by a plurality of slave mobility devices and one master mobility device.

FIG. 9(A) is a schematic configuration diagram of a radio transceiver used in a slave mobility device. FIG. 9(B) is a schematic configuration diagram of a radio transceiver used in a master mobility device.

FIG. 10 is a schematic configuration diagram of a distributed synthetic aperture radar system constituted by one master synthetic aperture radar device, a plurality of slave synthetic aperture radar devices, and one mobile control device.

FIG. 11 is a schematic configuration diagram of a distributed synthetic aperture radar system in which one master synthetic aperture radar device and M slave synthetic aperture radar devices transmit pulse signals to an observation target, and the one master synthetic aperture radar device and the M slave synthetic aperture radar devices receive reflected signals.

FIG. 12 is a schematic configuration diagram of a distributed synthetic aperture radar system in which one master synthetic aperture radar device transmits pulse signals to an observation target, and the one master synthetic aperture radar device and M slave synthetic aperture radar devices receive reflected signals.

### DESCRIPTION OF EMBODIMENTS

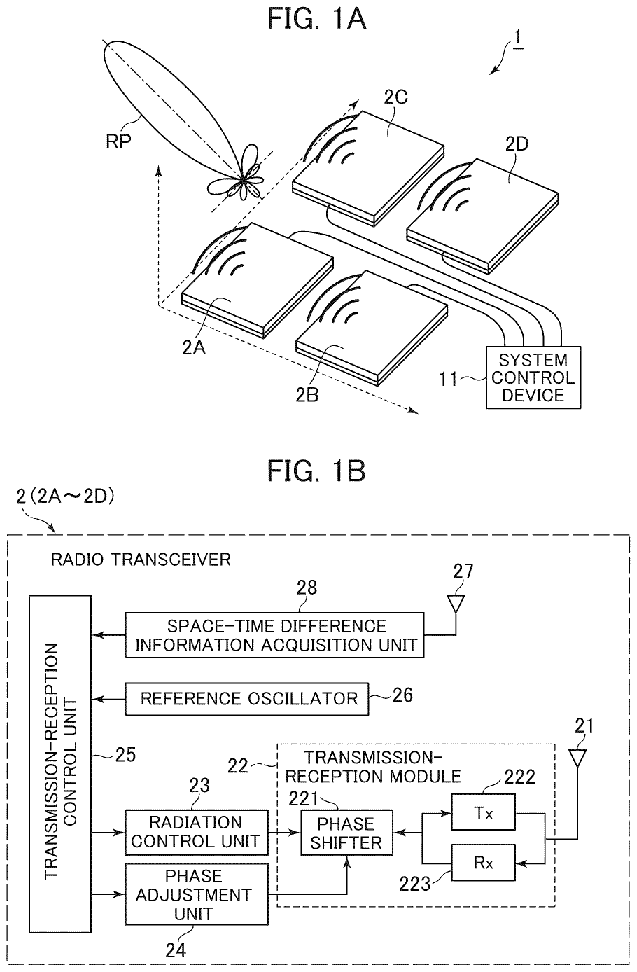

In the following, a detailed description of embodiments of the present invention will be described on the basis of the attached drawings. FIG. 1(A) illustrates a distributed phased array antenna system 1, which includes four radio transceivers 2 (for example, a first radio transceiver 2A, a second radio transceiver 2B, a third radio transceiver 2C, and a fourth radio transceiver 2D) and a system control device 11. The four radio transceivers 2 are arranged on a substantially flat surface facing the direction of communication. Note that the first to fourth radio transceivers 2A to 2D are arranged in a distributed manner at appropriate locations and all have a common function (for example, see FIG. 1(B)). In a case where the first to fourth radio transceivers 2A to 2D do not need to be distinguished from each other, the first to fourth radio transceivers 2A to 2D are simply referred to as radio transceivers 2. In addition, the number of radio transceivers 2 used to constitute the distributed phased array antenna system 1 is not limited to four, and may be two or three, or even five or more.

The radio transceivers 2 can be used as antenna elements that constitute a “phased array antenna system in which a plurality of antenna elements is arranged in an array to obtain a desired directivity”. That is, in the distributed phased array antenna system 1, the plurality of radio transceivers 2 is arranged, one or more or all of these radio transceivers 2 are excited in accordance with instructions from the system control device 11, and the desired directivity is obtained by superimposing radio waves obtained by controlling the excitation amplitude and phase.

Note that array antennas are classified into linear arrays, planar arrays, circular arrays, conformal arrays, and the like according to their array methods. Furthermore, array antennas that control the beam direction and radiation pattern using the relative phase of each radiating element are specifically referred to as phased array antennas. Antennas in which the radiating elements are separated without electrical connection and each radiating element controls itself independently are called distributed array antennas. Based on these existing technologies, a system according to the present invention that controls the beam direction and radiation pattern using the relative phase of the radio transceivers 2, which are independent radiation elements, is called the distributed phased array antenna system 1.

In order for the distributed phased array antenna system 1 to function as a phased array antenna, the system control device 11 needs to send directional characteristic control instructions to the first to fourth radio transceivers 2A to 2D, and the first to fourth radio transceivers 2A to 2D need to transmit reception signals to the system control device 11. Thus, the system control device 11 and the first to fourth radio transceivers 2A to 2D need to have a bidirectional signal transmission function. FIG. 1(A) illustrates an example in which the system control device 11 and the first to fourth radio transceivers 2A to 2D are connected by wire, but the system control device 11 and the first to fourth radio transceivers 2A to 2D may be connected in a wireless manner. In a case where the function of the system control device 11 is added to any one of the first to fourth radio transceivers 2A to 2D included in the distributed phased array antenna system 1, the system control device 11 does not have to be prepared additionally.

The radio transceivers 2 are housed in separate housings and can be handled individually, and thus the radio transceivers 2 are highly portable in a case where the radio transceivers 2 are sufficiently reduced in size and weight. Moreover, for example, the number and arrangement of radio transceivers 2 used as the distributed phased array antenna system 1 can be changed freely to control the radiation characteristics, thereby increasing the degree of freedom of the system. However, a negative factor of the radiating elements being distributed is that it is difficult to precisely align the radio transceivers 2 to an ideal arrangement, and this may result in an error factor. In addition, since the radio transceivers 2 are independent from each other, a reference clock, for example, needs to be generated for each radio transceiver 2. This results in an error factor because highly accurate synchronization with a common clock cannot be performed, as is the case with known phased array antennas. Thus, the radio transceivers 2 according to the present embodiment are provided with a function that can compensate for time errors and spatial errors, so that it becomes possible to suppress degradation in the beam quality that the distributed phased array antenna system 1 can obtain.

With reference to FIG. 1(B), an error correction function of the radio transceiver 2 illustrated as a first configuration example is described in detail below. Note that the signal communication function and processing operations of the radio transceiver 2 that are performed for the system control device 11 are omitted in FIG. 1(B) because various techniques used in known phased array antennas are applicable.

The radio transceiver 2 includes a communication antenna 21, a transmission-reception module 22, a radiation control unit 23, a phase adjustment unit 24, a transmission-reception control unit 25, a reference oscillator 26, an antenna 27 for synchronization, and a space-time difference information acquisition unit 28. Note that dipole antennas, slot antennas, and microstrip antennas are desirable for the communication antenna 21. The communication antenna 21, the transmission-reception module 22, the radiation control unit 23, and the phase adjustment unit 24 function as one radiation element included in the phased array. The radiation control unit 23 controls the frequency and intensity of radio frequency waves to be fed to the antenna, and the phase adjustment unit 24 controls the phase of the radio frequency waves. The transmission-reception module 22 includes a phase shifter 221, which can adjust the phase of each of the transmission and reception paths as desired, and amplification circuits (for example, an amplifier 222 for transmission and a low-noise amplifier 223 for reception). The transmission-reception module 22 switches between transmission of the radio frequency waves fed through the radiation control unit 23 and the phase shifter 221 to the communication antenna 21 and demodulation of radio frequency waves received by the communication antenna 21 after phase shifting. That is, the radio transceiver 2 can radiate and receive, from the communication antenna 21, radio waves with phases controlled as desired. Note that the following description of the radio transceivers 2 describes examples of an operation for radiating radio waves, but substantially the same effect can also be achieved in reception.

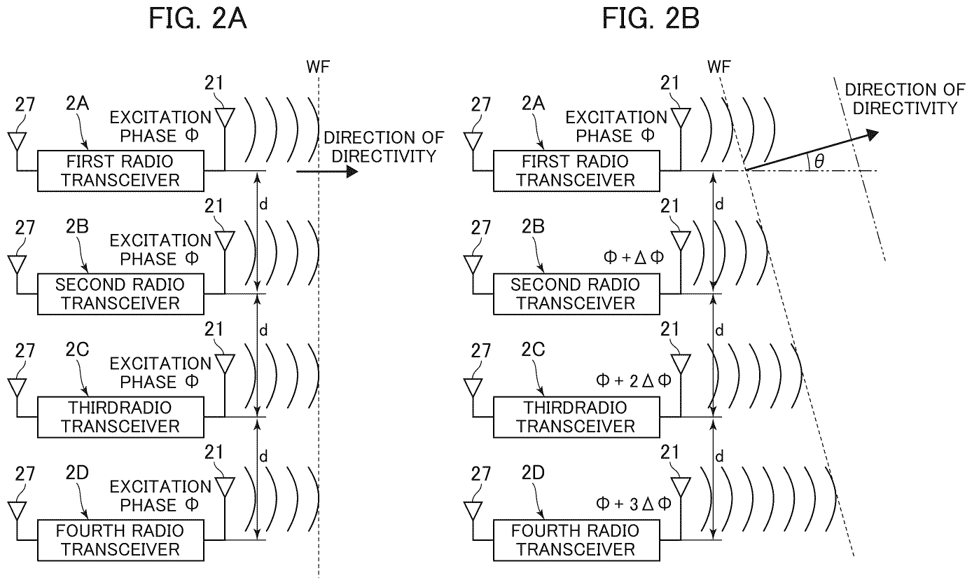

FIG. 2(A) illustrates the distributed phased array antenna system 1 with a linear array configuration in which the first to fourth radio transceivers 2A to 2D are linearly aligned with a distance of d between each radio transceiver. In addition, the clocks of the first to fourth radio transceivers 2A to 2D are synchronized with ideal precision. Thus, when radio frequency waves synchronized with an excitation phase Φ are transmitted from each of the transmission antennas 21 of the first to fourth radio receivers 2A to 2D, a composite wavefront WF is generated with an orientation orthogonal to the arrangement direction of the first to fourth radio transceivers 2A to 2D, as the direction of directivity. In contrast, FIG. 2(B) illustrates the case where radio frequency waves with the excitation phase Φ are transmitted from the transmission antenna 21 of the first radio transceiver 2A, those with the excitation phase Φ+Δφ from the transmission antenna 21 of the second radio transceiver 2B, those with the excitation phase Φ+2Δφ from the transmission antenna 21 of the third radio transceiver 2C, and those with the excitation phase Φ+3Δφ from the transmission antenna 21 of the fourth radio transceiver 2D. In this manner, when the radio frequency waves are transmitted with phases adjusted in accordance with the arrangement positions of the first to fourth radio transceivers 2A to 2D, the composite wavefront WF is generated with the direction of directivity tilted by an angle θ with respect to the direction of directivity illustrated in FIG. 2(A).

However, each radio transceiver 2 used in the distributed phased array antenna system 1 is not centrally managed, as is the case with known array antennas, and operates independently of the other radio transceivers 2. Thus, each radio transceiver 2 needs to grasp and control the state of the radio frequency signal such as the excitation amplitude and phase for the radio transceiver 2. A challenge in this case is to align the phase with the other radio transceivers 2 under certain rules. In order to do this, it is essential for each radio transceiver 2 to grasp time difference information and spatial difference information and to control the state of the radio frequency waves such that the phase shift amount necessary to obtain a desired composite wave is corrected. The time difference information is the time error between a radio transceiver 2 serving as a reference and the radio transceiver 2, and the spatial difference information is the spatial error between the proper position of the radio transceiver 2 relative to the radio transceiver 2 serving as the reference and the current position of the radio transceiver 2. Note that the time difference information may be the error between the reference oscillator 26 of the radio transceiver 2 serving as the reference and the reference oscillator 26 of the radio transceiver 2 or may be the error between the clock counting a reference frequency signal (for example, a reference clock signal) generated by the reference oscillator 26 of the radio transceiver 2 serving as the reference and the clock of the radio transceiver 2. The spatial difference information is acquired from the spatial error between the ideal position (the proper position) allocated to the radio transceiver 2 in the distributed phased array antenna system 1 and the current position of the radio transceiver 2, on the basis of the position of the radio transceiver 2 serving as the reference (hereinafter referred to as the reference device). Even in a case where the position of the reference device deviates slightly from the proper position, the distributed phased array antenna system 1 can achieve the intended directivity as long as the other radio transceivers 2 are arranged at the proper positions relative to the reference device.

The radio transceiver 2 is provided with the antenna 27 for synchronization and the space-time difference information acquisition unit 28 in addition to the reference oscillator 26. The space-time difference information acquisition unit 28 acquires space-time difference information, which includes both time and spatial difference information relative to other radio transceivers 2. On the basis of this space-time difference information, the phase adjustment unit 24 causes the phase shifter 221 of the transmission-reception module 22 to control the phase shift amount of the radio frequency signal to be emitted from the communication antenna 21. In this manner, by grasping the above-described space-time difference information including both the time difference information and the spatial difference information and correcting the time error and the spatial error, the desired composite wave can be obtained in a cooperative manner even in a case where a plurality of radio transceivers 2 operating independently is used. For example, the space-time difference information acquisition unit 28 transmits and receives codes to and from other radio transceivers 2 through wireless communication via the antenna 27 for synchronization and measures time difference information and the spatial difference information on the basis of the time shifts between the reference oscillators 26, and a propagation delay time associated with the code transmission and reception. Note that the phase shifts may be measured by communicating with other radio transceivers 2 connected by wire, without using the antenna 27 for synchronization.

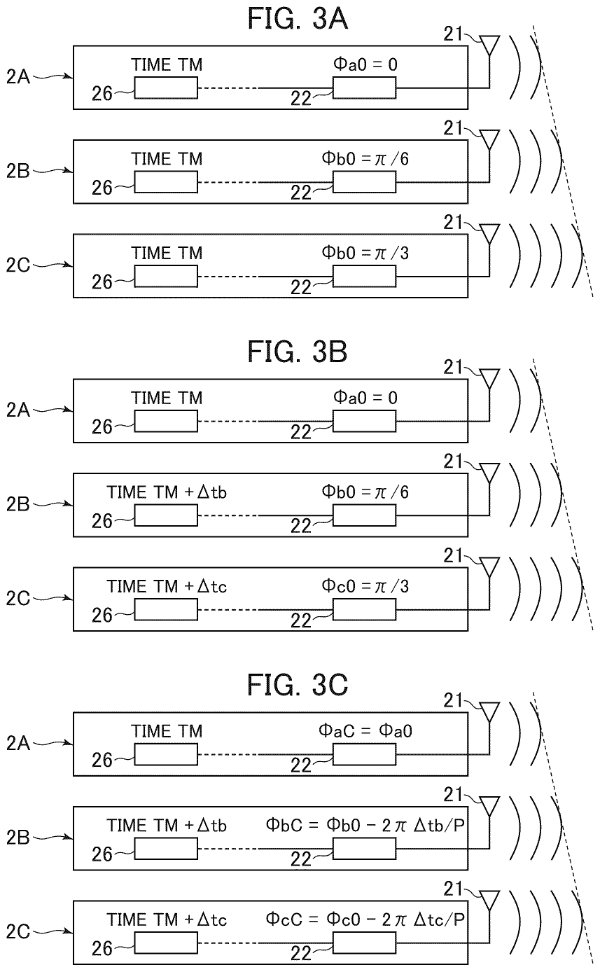

The space-time difference information including the time difference information and spatial difference information acquired by the space-time difference information acquisition unit 28 is supplied to the phase adjustment unit 24 via the transmission-reception control unit 25 and is used for phase shift correction control. That is, the radiation control unit 23 excites a radio frequency signal on the basis of the clock source of the reference oscillator 26, and the phase adjustment unit 24 controls the phase amount from the phase shifter 221 on the basis of the space-time difference information to correct the space-time error of the radio frequency signal, and transmits the radio frequency signal with a suppressed degradation in beam quality from the communication antenna 21. As a result, the distributed phased array antenna system 1 with the plurality of radio transceivers 2 operating independently can obtain the desired composite wave. Such a phase correction operation will be described with reference to FIG. 3. To simplify the description, FIG. 3 illustrates a linear array structure in which the first to third radio transceivers 2A to 2C are arranged in a row at equal intervals.

For example, as illustrated in FIG. 3(A), in a case where the reference oscillators 26 of the first to third radio transceivers 2A to 2C are synchronized with high precision and there is not a time error at a time TM, there is not a time error in the radio frequency signal supplied to the transmission-reception module 22. First, in a case where a phase shift amount Φa0 for the phase adjustment performed by the transmission-reception module 22 of the first radio transceiver 2A is set to 0 (zero) as instructed by the system control device 11, the radio frequency signal emitted from the communication antenna 21 has the phase specified by the instruction. Similarly, in a case where a phase shift amount Φb0 for the phase adjustment performed by the transmission-reception module 22 of the second radio transceiver 2B is set to π/6 as instructed by the system control device 11, the radio frequency signal emitted from the communication antenna 21 has the phase specified by the instruction.

Similarly, a phase shift amount Φc0 for the phase adjustment performed by the transmission-reception module 22 of the third radio transceiver 2C is set to π/3 (=2π/6) as instructed by the system control device 11, the radio frequency signal emitted from the communication antenna 21 has the phase specified by the instruction. In this manner, in a case where there is not a time error for each of the first to third radio transceivers 2A to 2C at the time TM, the wavefronts will be aligned in the direction of directivity in accordance with the phase differences between the radio frequency signals emitted from the respective communication antennas 21, and an appropriate directivity will be obtained.

However, as illustrated in FIG. 3(B), in a case where the time of each of the first to third radio transceivers 2A to 2C is not synchronized to the master clock, there will be a time error in the radio frequency signal supplied to the transmission-reception module 22. First, the clock of the first radio transceiver 2A is synchronized to the master clock (matches the time TM). Thus, the radio frequency signal that is phase adjusted (the phase shift amount Φa0=0) in the transmission-reception module 22 has the phase specified by the instruction. However, the clock of the second radio transceiver 2B is ahead of the master clock by Δtb, and thus the time TM+Δtb becomes the oscillation reference for the radio frequency signal. The radio frequency signal that is phase adjusted (the phase shift amount Φb0=π/6) in the transmission-reception module 22 is out of phase from the phase originally specified by the instruction. Moreover, the clock of the third radio transceiver 2C is ahead of the master clock by Δtc, and thus the time TM+Δtc becomes the oscillation reference for the radio frequency signal. The radio frequency signal that is phase adjusted (the phase shift amount Φc0=π/3) in the transmission-reception module 22 is out of phase from the phase originally specified by the instruction. Thus, regarding the radio frequency signals emitted from the respective communication antennas 21 in FIG. 3(B), the wavefronts will not be aligned in the direction of directivity in accordance with the phase differences, and an appropriate directivity cannot be obtained.

In contrast, as illustrated in FIG. 3(C), even in a case where the time of none of the first to third radio transceivers 2A to 2C is synchronized to the master clock, the time error that has occurred in the radio frequency signal can be eliminated when the phase amount is adjusted by the phase adjustment unit 24 so as to correct the time shift. Note that in the following, the period of the radio frequency signal to be transmitted is denoted as P. First, since the clock of the first radio transceiver 2A is synchronized to the master clock (matches the time TM), a correction phase adjustment amount ΦaC specified for the transmission-reception module 22 by an instruction from the phase adjustment unit 24 remains at Φa0 (=0), and the radio frequency signal emitted from the communication antenna 21 has the phase specified by the instruction.

However, since the clock of the second radio transceiver 2B is ahead of the master clock by Δtb, the phase adjustment unit 24 instructs the transmission-reception module 22 to use a correction phase adjustment amount ΦbC=Φb0-2πΔtb/P (=π/6-2πΔtb/P) obtained by taking the phase shift amount (2Δtb/P) caused by Δtb into consideration. As a result, the radio frequency signal emitted from the communication antenna 21 has the phase specified by the instruction. Since the clock of the third radio transceiver 2C is ahead of the master clock by Δtc, the phase adjustment unit 24 instructs the transmission-reception module 22 to use a correction phase adjustment amount ΦcC=Φc0-2πΔtc/P (=π/3-2πΔtc/P) obtained by taking the phase shift amount (2πΔtc/P) caused by Δtc into consideration. As a result, the radio frequency signal emitted from the communication antenna 21 has the phase specified by the instruction. In this manner, even in a case where there are time errors for the first to third radio transceivers 2A to 2C at the time TM, when the phase amounts are adjusted to correct the time shifts, the wavefronts will be aligned in the direction of directivity in accordance with the phase differences between the radio frequency signals emitted from the respective communication antennas 21, and an appropriate directivity will be obtained.

As described above, in a case where the space-time difference information is obtained between the independently operating radio transceivers 2 and the phase shift amounts of the radio frequency signals are corrected, the unintended phase shift of each wave source included in the composite wave can be reduced, and the beam quality of the distributed phased array antenna system 1 can be improved. Although only the time error correction method is illustrated in FIG. 3, the same is true for spatial error correction methods. In a case where the space-time difference information is obtained between the radio transceivers 2 and the phase shift amounts of the radio frequency signals are corrected, the unintended phase shift of each wave source included in the composite wave can be reduced. As a matter of course, in a case where both time and spatial errors have occurred, the unintended phase shift of each wave source included in the composite wave can be reduced by correcting the phases of the radio frequency signals while taking both the time and spatial error amounts into consideration.

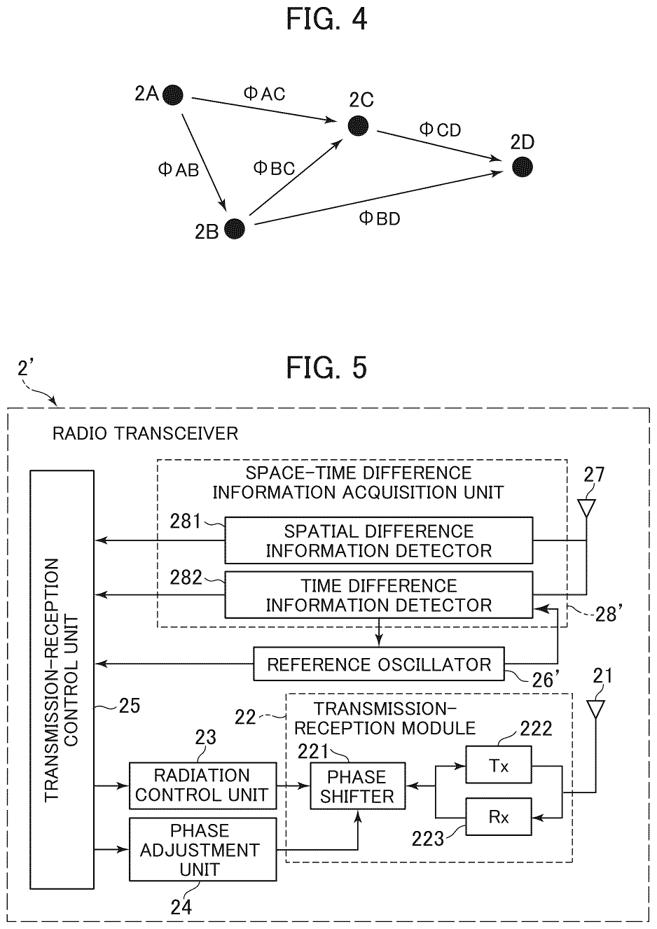

Note that the method for acquiring time difference information and the method for acquiring spatial difference information performed by the space-time difference information acquisition unit 28 are not particularly limited, and any known and existing method may be used as appropriate. For example, in a case where Global Navigation Satellite System (GNSS) is used, it is sufficient that GNSS be treated as the master clock and a correction operation for causing each radio transceiver 2 to synchronize to the time be performed. The method for performing time synchronization with GNSS is effective on the ground and in the sky where GNSS signals can reach. Various time synchronization methods, such as IEEE 802.1AS-2011, which use the propagation delay time between the individual radio transceivers 2, may also be used. In this case, one of the plurality of radio transceivers 2 constituting the distributed phased array antenna system 1 serves as the master clock or the plurality of radio transceivers 2 is made to be able to detect time shifts relative to the radio transceiver 2 serving as the reference. For example, as illustrated in FIG. 4, suppose that the first radio transceiver 2A has the master clock. The second radio transceiver 2B corrects its own clock using an error φAB based on the propagation delay time relative to the first radio transceiver 2A. Similarly, the third radio transceiver 2C corrects its own clock using an error φAC based on the propagation delay time relative to the first radio transceiver 2A. Note that the third radio transceiver 2C may correct its own clock using an error φBC based on the propagation delay time relative to the second radio transceiver 2B subjected to clock correction, or using the average value of the errors φAC and φBC. The fourth radio transceiver 2D may correct its own clock using an error φBD based on the propagation delay time relative to the second radio transceiver 2B subjected to clock correction or an error φCD based on the propagation delay time relative to the third radio transceiver 2C subjected to clock correction, or using the average value of the errors φBD and φCD. This method in which the propagation delay time (round-trip time (RTT)) is used provides high synchronization precision, and thus this method is desirable in terms of improving beam quality.

Instead of correcting the time phase shift, the reference oscillator 26 may be adjusted to eliminate (i.e., synchronize) the phase shift of the reference oscillator 26 such that the detected phase shift is canceled. For example, a radio transceiver 2′ illustrated in FIG. 5 includes a frequency-adjustable reference oscillator 26′, such as a voltage controlled oscillator (VCO) or an oven controlled crystal oscillator (OCXO), and a space-time difference information acquisition unit 28′, which includes a spatial difference information detector 281 and a time difference information detector 282. The time difference information detector 282 receives information indicating the master clock or its phase from the antenna 27 for synchronization, and causes the excitation phase of the reference oscillator 26′ to match the master clock on the basis of the received information. More specifically, the radio waves of a specific frequency transmitted from the master clock are received by the antenna 27 for synchronization, and the phase shift between the clock of the reference oscillator 26′ and the radio waves is detected by the time difference information detector 282. The time error obtained by the time difference information detector 282 can be fed back to the reference oscillator 26′ to excite the reference oscillator 26′ in phase with the master clock. In this manner, in a case where the oscillation clock of the reference oscillator 26′ is synchronized to the master clock at the phase level, the phase shift can be minimized and the beam quality can be improved. The master clock does not have to be global, but can be used for local synchronization that is achieved only between the plurality of radio transceivers 2 constituting the distributed phased array antenna system 1. In this case, it is sufficient that the radio transceiver 2 serving as the master clock be freely selected from among the plurality of radio transceivers 2 constituting the distributed phased array antenna system 1.

In contrast, spatial difference information, namely the positional relationship between the plurality of radio transceivers 2, can be detected using radio-based positioning techniques, such as distance estimation using GNSS, Angle of Arrival (AoA), Angle of Departure (AoD), and Received Signal Strength Indicator (RSSI). In particular, GNSS is effective in a case where the radio transceivers 2 are arranged at places where GNSS signals can reach, such as on the ground or in the air. Regarding acquisition of spatial difference information, not global positions, such as latitude, longitude, and altitude, but local information may be used with which the relative positional relationship can be grasped only between the plurality of radio transceivers 2 constituting the distributed phased array antenna system 1. Thus, a positioning technique may also be used that uses, for example, AoA, AoD, or RSSI to allow the plurality of radio transceivers 2 to grasp each other's position. Furthermore, the positional relationship may be grasped by determining the distance to and from each other using the propagation delay time of radio waves. In this case, it is sufficient that the distance between the plurality of radio transceivers 2 be determined.

The spatial difference information obtained in this manner is used for the transmission-reception control unit 25 to determine a phase shift amount. For example, in a case where the device is deviated from the ideal arrangement of the array antenna, the phase shift due to the spatial error is obtained and the phase shift amount is adjusted to minimize the effect on beam quality. Desirably, this phase shift amount is calculated using Maxwell's equations, Fresnel-Kirchhoff diffraction theory, ray tracing, or other methods, and the value that results in an optimal beam as a whole is used. More simply, the phase shift may be calculated from the distance representing the shift from the ideal position and the propagation wavelength of the radio waves, and the phase of the radio frequency signal may be adjusted to correct this spatial error.

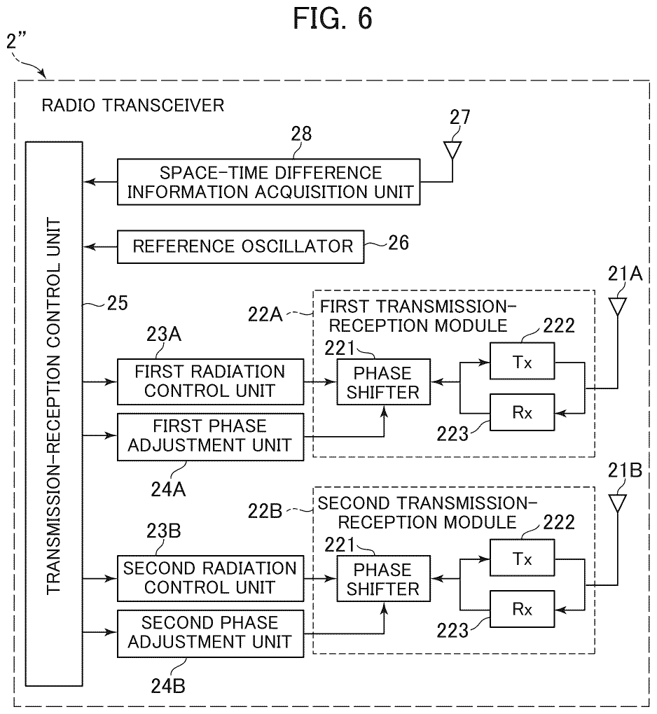

The number of radiating element functions installed in the radio transceivers 2 is not limited to one. N (N is any natural number) communication antennas 21 and transmission-reception modules 22 corresponding to the respective transmission antennas 21 may be provided. A radio transceiver 2″ illustrated in FIG. 6 has two pairs (N=2) of radiating element functions and includes a first communication antenna 21A, a second communication antenna 21B, a first transmission-reception module 22A, and a second transmission-reception module 22B. The first and second transmission-reception modules 22A and 22B correspond to the first and second transmission antennas 21A and 21B, respectively. The radio frequency signal radiated from the first communication antenna 21A and the radio frequency signal radiated from the second communication antenna 21B are controlled independently. Thus, a first radiation control unit 23A and a first phase adjustment unit 24A corresponding to the first transmission-reception module 22A are provided, and a second radiation control unit 23B and a second phase adjustment unit 24B corresponding to the second transmission-reception module 22B are provided. In this manner, in the radio transceiver 2″ equipped with the plurality of radiating element functions, the radiating element functions can be arranged so as to have a narrow spacing therebetween. For example, in a case where an element spacing is d, a signal wavelength is λ, and the maximum scanning angle is θ, then d/λ=1/(1+sinθ). Thus, in a case where the element spacing d is adjusted so that d≤λ/(1+sin0), the generation of grating lobes can be suppressed.

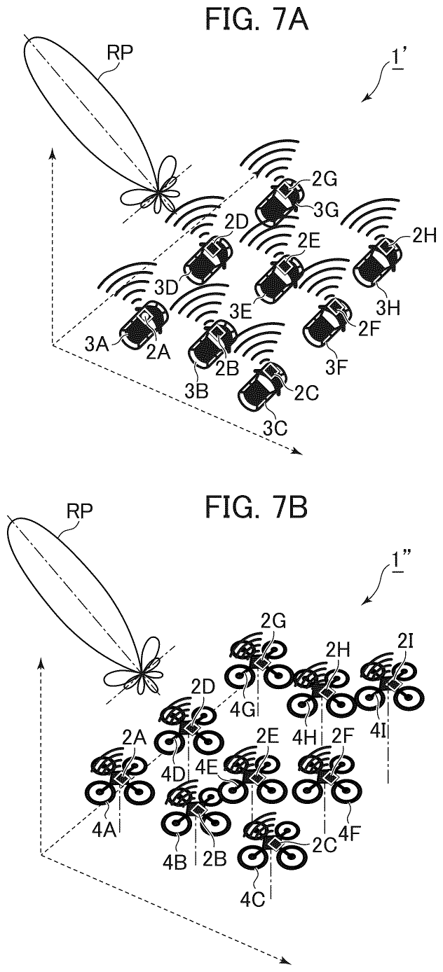

As described above, the radio transceiver 2, which can acquire time difference information and spatial difference information and adjust the phase of the radio frequency signal so as to correct the amount of pace-time error, can not only use the radiating elements of the array antenna independently, but can also be included in a mobile distributed phased array antenna system by being further mounted on a mobile means. Examples of mobile units to be equipped with the radio transceivers 2 include vehicles 3 (see FIG. 7(A)) traveling on the ground, ships sailing on the sea, aircrafts or unmanned aerial vehicles (UAV) 4 (see FIG. 7(B)) flying in the airspace, and satellites in orbit. Note that such a mobile unit and the radio transceiver 2 may be integrated into a single structure instead of being separate units.

A mobile distributed phased array antenna system 1′ illustrated in FIG. 7(A) is obtained by mounting first to eighth radio transceivers 2A to 2H on first to eighth vehicles 3A to 3H, respectively. For example, the first radio transceiver 2A has the function of the system control device 11. In this distributed phased array antenna system 1′, the relative positions of the first to eighth radio transceivers 2A to 2H change from time to time as the first to eighth vehicles 3A to 3H move because each of the radio transceivers 2 is not fixedly arranged, unlike in the above-described distributed phased array antenna system 1. However, since each radio transceiver 2 includes the space-time difference information acquisition unit 28, the radio transceiver 2 can acquire time difference information and spatial difference information and emit the radio frequency signal with the corrected amount of space-time error, and can follow changes in the amount of space-time error as the first to eighth vehicles 3A to 3H move. Thus, even in the mobile distributed phased array antenna system 1′ using the vehicles 3, which are mobile units, it is possible to form a composite wave with the main lobe directed in a specific direction.

Note that in a case where the first to eighth vehicles 3A to 3H are autonomous driving vehicles or the like, the first to eighth vehicles 3A to 3H can move in formation so that the first to eighth radio transceivers 2A to 2H are ideally arranged as an array antenna. Thus, the distributed phased array antenna system 1′ can move while maintaining the beam quality therein. In addition, the first to eighth radio transceivers 2A to 2H can grasp each other's positions from the space-time difference information acquired from the space-time difference information acquisition units 28. Thus, to achieve the ideal arrangement as an array antenna, each radio transceiver 2 can determine the way in which the radio transceiver 2 moves. Thus, in a case where each radio transceiver 2 is equipped with a movement correction instruction means and where the movement correction instruction means transmits movement correction information to a movement control device of each mobile unit (for example, the autonomous driving control device of the vehicle 3) and then the movement control device of each mobile unit corrects the direction and speed of movement on the basis of the movement correction information, each mobile unit can move the corresponding radio transceiver 2 to its optimal position. Note that even in a case where the optimal arrangement of each radio transceiver 2 cannot be achieved only through the movement correction of each mobile unit, the radio transceiver 2 performs a phase correction operation on the radio frequency signal on the basis of the space-time difference information detected at that time. As the distributed phased array antenna system 1′, the degradation in beam quality can thus be minimized. As a matter of course, even in a case where the movement correction of the mobile unit cannot be properly performed (for example, when a person drives the vehicle), the degradation in the quality of the composite wave can be suppressed by each radio transceiver 2 performing the phase correction operation on the radio frequency signal.

A mobile distributed phased array antenna system 1″ illustrated in FIG. 7(B) is obtained by mounting first to ninth radio transceivers 2A to 21 on first to ninth UAVs 4A to 4I, respectively. For example, the first radio transceiver 2A has the function of the system control device 11. In this distributed phased array antenna system 1″, the radio transceivers 2 are mounted on the respective UAVs 4, which are mobile units that can fly, so that the array arrangement that makes use of three-dimensional space can be achieved. For example, the functions of array antennas with three-dimensional curved surfaces for which it is difficult to achieve a large aperture can be easily realized by the distributed phased array antenna system 1″. In a case where the gain the power amplifier in the reception module 22 of each radio transceiver 2 is not variable, the degradation in beam quality can be suppressed by fine-tuning the three-dimensional arrangement of the individual radio transceivers 2 to suppress variations between the power amplifiers.

In a case where the UAVs 4 are of an autonomous flight type, each radio transceiver 2 is equipped with a movement correction instruction means, and the movement correction instruction means transmits movement correction information to the movement control device of each mobile unit (for example, an autonomous flight rotation control device of the UAV 4). As a result, in a case where the movement control device of each mobile unit corrects the direction and speed of movement on the basis of the movement correction information, each mobile unit can move the corresponding radio transceiver 2 to its optimal position. In a case where each UAV 4 is an unmanned vehicle that can be remotely operated through wireless communication, each radio transceiver 2 may be equipped with a movement control unit that controls the movement of the mobile unit, and the movement control unit of each radio transceiver 2 may directly control the corresponding UAV 4. In this case, in addition to relative movement control of the individual radio transceivers 2 constituting the distributed phased array antenna system 1″, the movement control units also perform movement control to correct the phase shifts based on the space-time difference information acquired by the space-time difference information acquisition units 28. Until each radio transceiver 2 is moved to the ideal arrangement under the movement control performed on each UAV 4 by the movement control unit of the corresponding radio transceiver 2, the degradation in beam quality can be suppressed by each radio transceiver 2 correcting the of the radio frequency signal.

Furthermore, in the distributed phased array antenna system 1″, each UAV 4 can be set in an arrangement where the radio transceivers 2 constitute an unequally spaced array as a whole, taking advantage of the fact that the UAVs 4 can be arranged in a free formation. In a case where an unequally spaced array arrangement is adopted, the number of elements (the number of radio transceivers 2 used) can be reduced because the elements can be arranged with wider spacing than under normal grating lobe generation conditions. Furthermore, in the unequally spaced array, the amplitude distribution can be equivalently applied on the basis of the array density of the elements. Thus, even in a case where the amplitude distribution of each radio transceiver 2 is constant, low sidelobes can be achieved, so that the directivity of the distributed phased array antenna system 1″ can be further improved.

As described above, in a case where the radio transceivers 2 are mounted on mobile units, such as the vehicles 3 or the UAVs 4, each of the distributed phased array antenna systems 1′ and 1″, as a whole, is equipped with a movement means and is thus highly convenient. Moreover, depending on the use of each of the distributed phased array antenna systems 1′ and 1″, the arrangement of the radio transceivers 2 can be changed by moving the mobile units, thereby providing a high degree of freedom. In addition, in a case where the radio transceivers 2 are mounted on mobile units to add a movement function, the distributed phased array antenna systems 1′ and 1″ can achieve scalability, which enables flexible handling of changes in scale. As a result, the advantages of the distributed systems can be maximized. example, each radio transceiver 2 has a self-diagnostic unit that can diagnose malfunctions and the like that have occurred in itself, and an autonomous movement control unit that can freely control the movement of the mobile unit equipped with the radio transceiver 2. When the self-diagnostic unit of a certain radio transceiver 2 included in the distributed phased array antenna system 1′ or 1″ determines that the radio transceiver 2 has failed, the autonomous movement control unit causes the radio transceiver 2 to autonomously move and leave the array arrangement. If the other radio transceivers 2 autonomously adjust their arrangement to fill this gap, the effect of the failure caused by one or some of the radio transceivers 2 can be minimized, and the distributed phased array antenna system 1′ or 1″ can continue to operate. Note that in a case where a radio transceiver 2 is on standby as a spare device, the spare device may autonomously move to the proper position in place of the radio transceiver 2 that has dropped out because of a failure, so that the proper array arrangement can be restored quickly. Moreover, in a situation where the diagnosis made by the self-diagnostic unit of the radio transceiver 2 is that the radio transceiver 2 cannot radiate radio waves at its original output but can radiate weak radio waves, the effect of the failure can be reduced by rearranging the radio transceiver 2 with reduced radiation performance to the outermost part of the array arrangement. Each radio transceiver 2 may be arrayed considering the variation in the radiation characteristics of each radio transceiver 2, such that the radio transceivers 2 form an optimal unequally spaced array. In a case where the autonomous movement control unit of each radio transceiver 2 has a self-learning function through reinforcement learning, autonomous control becomes possible in which under the autonomous control, each radio transceiver 2 can self-learn the optimal solution, with which the distributed phased array antenna system 1′ or 1″ can obtain the desired composite wave, and the autonomous movement control units of the radio transceivers 2 autonomously reconfigure the arrangement considering the radiation characteristics, for example, of each radio transceiver 2. If each radio transceiver 2 has such a self-learning function, the degradation of the composite wave can be minimized for the distributed phased array antenna system 1′ or 1″ even when the radiation characteristics of each radio transceiver 2 change because of age-related deterioration, for example.

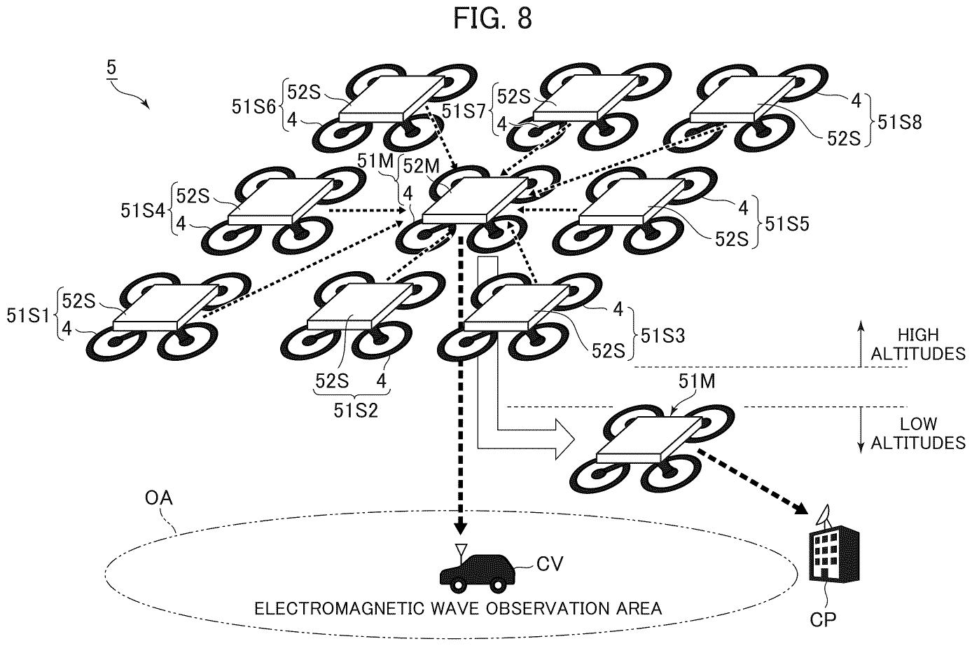

The distributed phased array antenna system 1, 1′, or 1″ described above uses, for example, the radio transceivers 2, 2′, or 2″ that can acquire the space-time difference information to suppress degradation in the quality of transmission beams. However, the radio transceivers that can acquire space-time difference information can also be applied to beamforming, which can form reception beams with various directivities by synthesizing reception signals through appropriate phase shift processing and appropriate weighting processing (amplification and attenuation in the amplitude direction). FIG. 8 illustrates a distributed electromagnetic wave observation data collection system 5 that uses beamforming techniques to collect data for observing arriving electromagnetic waves. This distributed electromagnetic wave observation data collection system 5 can be used for radio wave observation by itself and can also be used as distributed individual antennas (for example, a radio telescope) for observation using Very Long Baseline Interferometry (VLBI).

This distributed electromagnetic wave observation data collection system 5 is constituted by, for example, one master mobility device 51M and first to eighth slave mobility devices 51S1 to 51S8 (simply referred to as slave mobility devices 51S when no particular distinction is necessary) above a radio observation area OA, which is freely set. The first to eighth slave mobility devices 51S1 to 51S8 and the master mobility device 51M each receives radio waves arriving in the radio observation area OA, and the first to eighth slave mobility devices 51S1 to 51S8 transmit the reception data (observation data) to the master mobility device 51M. The master mobility device 51M, which has collected the observation data, then moves to lower altitudes at a predetermined data transfer timing (for example, at regular time intervals or when the storage capacity for observation data reaches a predetermined value) and transmits the observation data to an observation data collection station CP, which serves as the observation data collection center, from a relatively short distance. In this manner, if the master mobility device 51M is operated to temporarily move to lower altitudes to transmit observation data, it is possible to perform high-capacity communication with less transmission power than in a case where the observation data is transmitted directly from high altitudes to the observation data collection station CP.

In the observation data collection station CP that has received the observation data, the reception signals of the collected observation data collected by the master mobility device 51M and the first to eighth slave mobility devices 51S1 to 51S8 are synthesized through appropriate phase shift processing and appropriate weighting processing, so that a reception beam can be generated. In this case, reception beams of different patterns can be generated by using different combinations of the phase shift processing and weights for respective reception signals. That is, various beam pattern outputs can be obtained from the observation data of electromagnetic waves received by the master mobility device 51M and first to eighth slave mobility devices 51S1 to 51S8 that are arrayed in a predetermined manner.

Note that the method for transferring observation data collected by the master mobility device 51M to the observation data collection center is not particularly limited. For example, a data collection vehicle CV that receives the observation data may be kept on standby within the electromagnetic wave observation area OA, and the operation may be performed in which the master mobility device 51M directly transmits the observation data to the data collection vehicle CV. Alternatively, the operation may be performed in which the master mobility device 51M stores the observation data in a recording medium, an investigator or the like removes the recording medium with the stored observation data from the master mobility device 51M that has descended to the ground at the data transfer timing, the investigator or the like replaces the recording medium with a recording medium with sufficient free capacity, and the master mobility device 51M is then returned to its designated position in the sky quickly. Alternatively, the operation may be performed in which the master mobility device 51M and the first to eighth slave mobility devices 51S1 to 51S8 move to the electromagnetic wave observation area OA to observe electromagnetic waves on the ground, and only the master mobility device 51M moves to, for example, the observation data collection station CP at a predetermined data transfer timing to transfer the stored observation data.

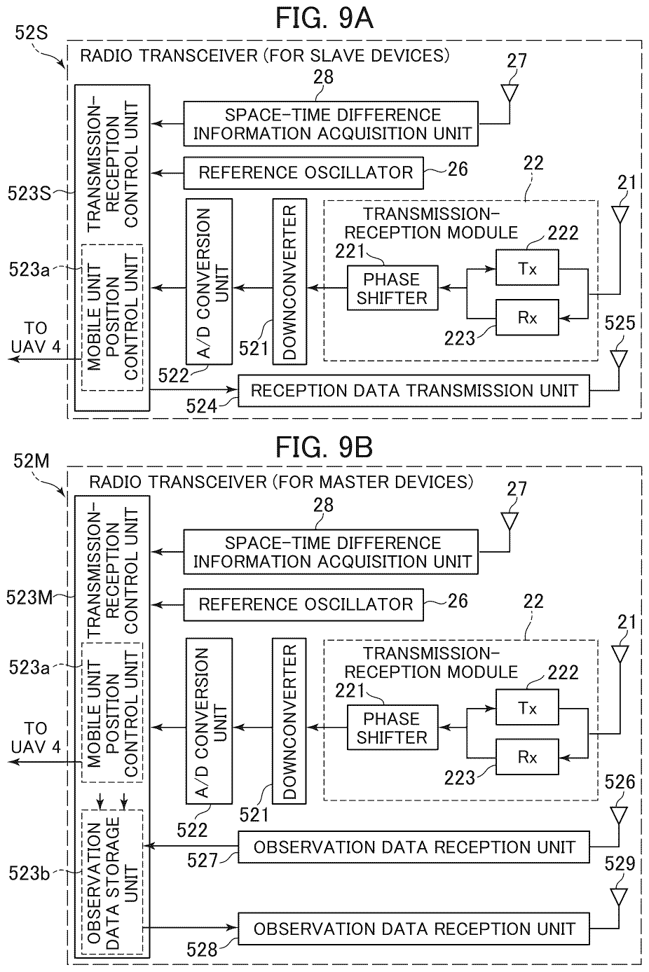

The master mobility device 51M is obtained by mounting a radio transceiver 52M on a UAV 4. In contrast, the first slave mobility device 51S1 is obtained by mounting a radio transceiver 52S on a UAV 4. Similarly, the second slave mobility device 51S2, the third slave mobility device 51S3, the fourth slave mobility device 51S4, the fifth slave mobility device 51S5, the sixth slave mobility device 51S6, the seventh slave mobility device 51S7, and the eighth slave mobility device 51S8 are each obtained by mounting a radio transceiver 52S on a UAV 4. In the following, the radio transceiver 52S for slave devices and the radio transceiver 52M for master devices will be described with reference to FIG. 9.

FIG. 9(A) illustrates a schematic configuration of the radio transceiver 52S for the slave mobility device 51S. The radio transceiver 52S for the slave mobility device 51S does not have to have the function of emitting beams on its own. Thus, only the reception function is illustrated in FIG. 9(A), but the radio transceiver 52S for the slave mobility device 51S may have a phase-correctable transmission function similar to those of the radio transceivers 2, 2′, and 2″ described above. If the radio transceiver has both a transmission function that uses space-time difference information for phase correction during transmission and a reception function that makes space-time difference information available for phase correction of the reception signal, the radio transceiver can be used in the distributed phased array antenna system 1, 1′, or 1″ and in the distributed electromagnetic wave observation data collection system 5. Thus, the radio transceiver can be highly versatile. Note that in FIG. 9(A) and 9(B), the same functions as those of the radio transceiver 2 in FIG. 1(B), the radio transceiver 2′ in FIG. 5, and the radio transceiver 2″ in FIG. 6 are denoted by the same reference signs and description will be omitted.

The radio transceiver 52S includes one communication antenna 21, a space-time difference information acquisition unit 28, a transmission-reception module 22, which serves as one signal reception unit corresponding to the communication antenna 21, a reception data transmission unit 524, and a reference oscillator 26, which generates a reference frequency signal. Signals received by the transmission-reception module 22 are converted by a downconverter 521 into intermediate frequencies or the like that are easy to handle. The intermediate frequencies or the like are further converted by an analog-to-digital (A/D) conversion unit 522 into digital signals. The digital signals are input to a transmission-reception control unit 523S. Note that the beamforming processing using reception signals obtained from a plurality of antennas can be realized by using analog circuits, but digital signal processing is more flexible and realistic.

In contrast, the space-time difference information acquisition unit 28 transmits and receives codes to and from another radio transceiver 52S or a radio transceiver 52M in both ways through wireless communication using an antenna 27 for synchronization different from the communication antenna 21, measures time difference information and spatial difference information on the basis of the time shift between the reference oscillators 26 and the propagation delay time associated with the code transmission and reception, and acquires space-time difference information including the time difference information and the spatial difference information. The time difference information is the time error between the radio transceiver 52S and the radio transceiver 52S or 52M serving as a reference, and the spatial difference information is the spatial error between the current position and the proper position of the radio transceiver 52S relative to the radio transceiver 52S or 52M serving as the reference. This space-time difference information is input to the transmission-reception control unit 523S. Note that in a case where a reference device is selected from among the radio transceiver 52M of the master mobility device 51M and the radio transceivers 52S of all the slave mobility devices 51S, where the reference oscillator 26 of the selected reference device is set as the master clock, and where the reference oscillators 26 of the other radio transceivers 52M and 52S are synchronized to the master clock, a time error does not occur in the reception signal, and thus only the spatial difference information may be acquired as the space-time difference information.

The transmission-reception control unit 523S that has received the reception signal and the space-time difference information in the above-described manner passes a set of the digitized reception signal and space-time difference information at the reception timing to the reception data transmission unit 524. The reception data transmission unit 524 transmits the reception data to the radio transceiver 52M of the master mobility device 51M via an antenna 525 for reception data transmission. In the reception data, the reception signal received by the transmission-reception module 22 serving as the reception unit, the space-time difference information at that reception timing, and the unique information regarding the radio transceiver 52S (for example, an ID number that has been freely set, or a chip ID that is unique to the transmission-reception module 22) are associated with each other. The unique information regarding the radio transceiver 52S has been set so that the radio transceiver 52S can be distinguished from the other radio transceivers 52S and 52M.

Note that in a case where a plurality of communication antennas 21 and the corresponding reception units (the transmission-reception modules 22, the downconverters 521, and the A/D conversion units 522) are provided, it is sufficient that the reception data transmission unit 524 ensure that the reception data includes information that can identify each reception unit in the radio transceiver 52S. A transmission-reception control unit 523 may include a mobile unit moves position control unit 523a, so that the UAV 4 serving as a mobile unit to correct the position of the radio transceiver 52S on the basis of the spatial difference information in the space-time difference information such that the radio transceiver 52S is brought closer to the proper position.

FIG. 9(B) illustrates the schematic configuration of the radio transceiver 52M of the master mobility device 51M, to which reception data is transmitted from the radio transceiver 52S of the above-described slave mobility device 51S.

The reception data received from each radio transceiver 52S via an observation data receiving antenna 526 and an observation data reception unit is stored as observation data in an observation data storage unit 523b. Note that it is sufficient that the master mobility device 51M have the function of collecting and transferring observation data to a data collection center, but the radio transceiver 52S also includes the reception unit (the transmission-reception module 22, the downconverter 521, and the A/D conversion unit 522) such that the master mobility device 51M can also observe electromagnetic waves. Thus, the reception signal and space-time difference information received by the radio transceiver 52M and also the unique information regarding the radio transceiver 52M are stored as observation data in the observation data storage unit 523b.

When a transmission-reception control unit 523M determines that a predetermined data transfer timing has been reached, the master mobility device 51M moves to lower altitudes by sending an instruction to the UAV 4 serving as a mobile unit from the mobile unit position control unit 523a, and transfers the observation data to the data collection center via an observation data transmission unit 528 and an antenna 529 for observation data transmission. When the transfer of the observation data is completed, the master mobility device 51M returns to the predetermined observation position again and restarts radio wave observation.

In this manner, the distributed electromagnetic wave observation data collection system 5 uses the master mobility device 51M, which is obtained by mounting the radio transceiver 52M on the UAV 4, and the first to eighth slave mobility devices 51S1 to 51S8, which are obtained by mounting the radio transceivers 52S on the UAVs 4, and can suppress degradation in beam quality by using, as correction information, the space-time difference information acquired by each of the radio transceivers 52M and 52S. That is, on the basis of the space-time difference information regarding the reception signals, the observation data collection station CP, which has received the observation data, corrects the phases of the respective reception signals of the observation data collected by the master mobility device 51M and the first to eighth slave mobility devices 51S1 to 51S8 to improve the precision of the reception signals, and can generate a high-quality reception beam by synthesizing the highly precise reception signals through appropriate phase shift processing and appropriate weighting processing. Note that the space-time difference information acquisition unit 28 included in each of the radio transceivers 52S and 52M may acquire, as spatial difference information, the current relative position of the radio transceiver 52S or 52M to the radio transceiver 52S or 52M serving as the reference. This is because if the observation data collection station CP that has received the observation data from the master mobility device 51M can grasp the relative positions of the other radio transceivers 52S and 52S to the radio transceiver 52S or 52S serving as the reference in the observation data for each radio wave reception time, the observation data collection station CP can perform appropriate phase shift processing and appropriate weighting processing considering the relative position shifts of the radio transceivers 52S and 52M.

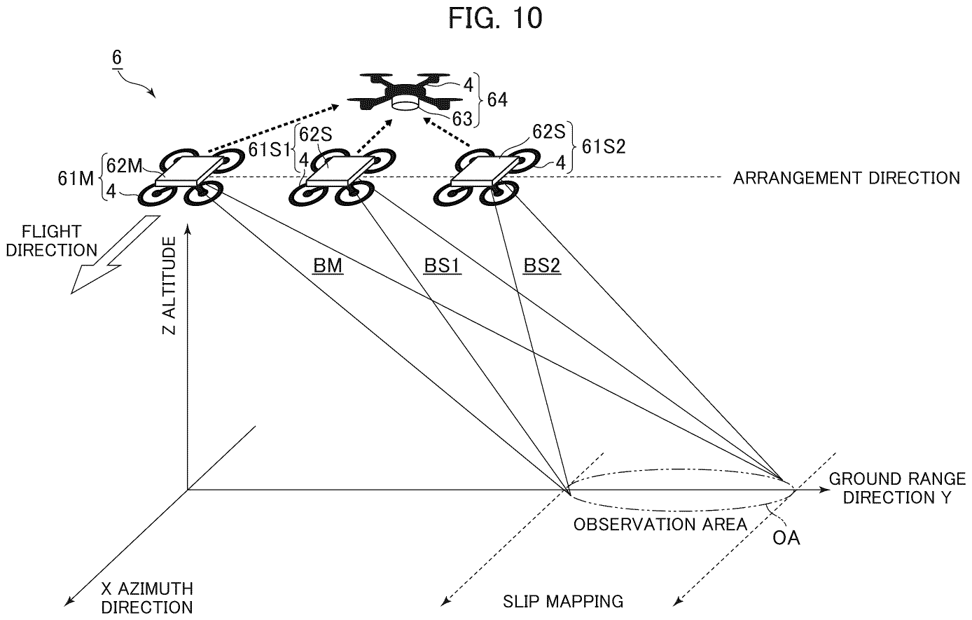

The examples have been illustrated in which the radio transceivers 2, 2′, 2″, 52M, and 52S, which can acquire pace-time difference information, are used in the distributed phased array antenna systems 1, 1′, and 1″ and the distributed electromagnetic wave observation data collection system 5; however, the radio transceivers 2, 2′, 2″, 52M, and 52S can also be used as passive radars and active radars. The larger the aperture, the higher the resolution of the radar, but it is not easy to manufacture and operate a large aperture radar. However, distributed radars, such as the radio transceivers 2, 2′, 2″, 52M, and 52S described above, would be easier to manufacture and operate. As an example, FIG. 10 illustrates a distributed synthetic aperture radar system 6 applied to a synthetic aperture radar (SAR), which can generate two-dimensional images by processing reception signals obtained by repeatedly transmitting and receiving pulses while moving over an image acquisition area in an azimuth direction.

The distributed SAR system 6 includes, for example, a master SAR device 61M, a first slave SAR device 61S1, a second slave SAR device 61S2, and a phase control device 64. The master SAR device 61M is obtained by mounting a radio transceiver 62M on a UAV 4 serving as a mobile unit. The first slave SAR device 61S1 and the second slave SAR device 61S2 are obtained by mounting radio transceivers 62S on UAVs 4 serving as mobile units. The phase control device 64 is obtained by mounting an SAR signal processing device 63 on a UAV 4 serving as a mobile unit.

The flight direction of the master SAR device 61M is the azimuth direction, and the master SAR device 61M repeatedly transmits pulse signals for observation and receives reflected signals so that an observation area OA is formed as an image acquisition area in a ground range direction orthogonal to this azimuth direction. The first slave SAR device 61S1 and the second slave SAR device 61S2 are arranged in a row with the master SAR device 61M in an array direction parallel to the ground range direction, and repeatedly transmit pulse signals to and receive reflected signals from the same observation area OA as the master SAR device 61M. That is, a radiation beam BM of the master SAR device 61M, a radiation beam BS1 of the first slave SAR device 61S1, and a radiation beam MS2 of the second slave SAR device 61S2 are equally radiated to the observation area OA, and the observation area OA gradually shifts in the azimuth direction (slip mapping). The master SAR device 61M and the first and second slave SAR devices 61S1 and 61S2 are separated by intervals of about several tens of centimeters to several meters. In a case where the master SAR device 61M and the first and second slave SAR devices 61S1 and 61S2 are flying at an altitude of several hundred meters, this can be regarded from the observation area OA as a state where pulse signals are transmitted from a single radiation source. Note that the number of slave SAR devices 61S is not limited to two and may be one, three, or more.

The mobile control device 64 flies following the master SAR device 61M and the first and second slave SAR devices 61S1 and 61S2, and receives reception data from the master SAR device 61M and the first and second slave SAR devices 61S1 and 61S2. The SAR signal processing device 63, which has received the reception data from the master SAR device 61M and the first and second slave SAR devices 61S1 and 61S2, processes the reception data to generate a two-dimensional image. Note that as a processing process performed by the SAR signal processing device 63, for example, the ground range direction is resolved through execution of correlation processing between the reflected signal obtained by transmitting a frequency-modulated chirp signal to the observation area OA and a reference signal (a section of the chirp pulse), and the azimuth direction is resolved through execution of correlation processing between the reception signal and reference waves calculated by taking into consideration the Doppler effect due to the flight speeds of the master SAR device 61M and first and second slave SAR devices 61S1 and 61S2.

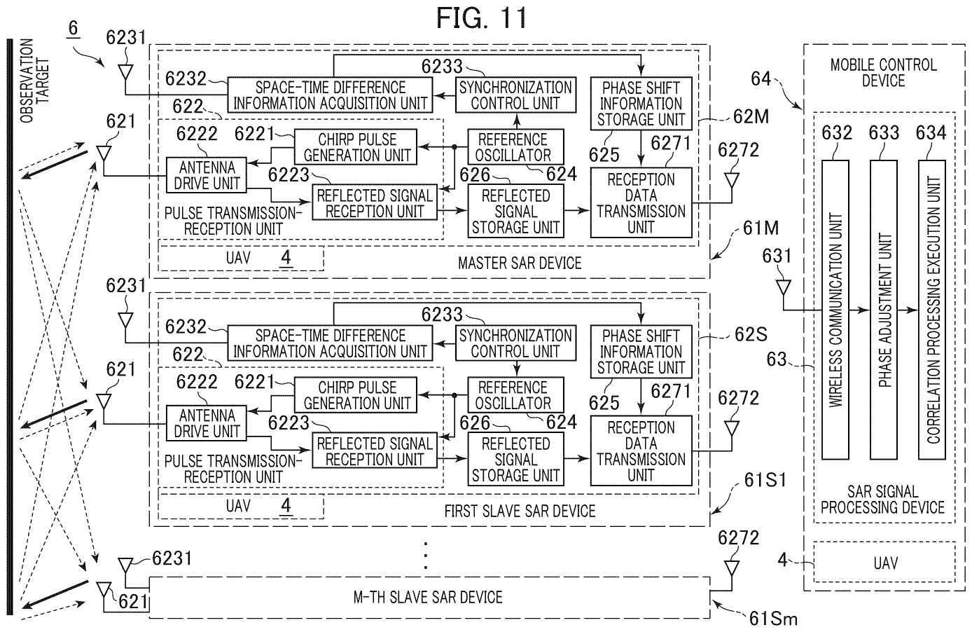

Next, the detailed functions of the master SAR device 61M, first to M-th slave SAR devices 61S1 to 61Sm, and the phase control device 64 each included in the distributed SAR system 6 will be described based on FIG. 11.

For example, the radio transceiver 62M of the master SAR device 61M includes a pulse transmission-reception unit 622 that transmits and receives pulse signals via a communication antenna 621. Moreover, the radio transceiver 62M of the master SAR device 61M includes a space-time difference information acquisition unit 6232. The space-time difference information acquisition unit 6232 transmits and receives codes to and from other radio transceivers 62S in both ways through wireless communication using an antenna 6231 for synchronization different from the communication antenna 621, measures time difference information and spatial difference information on the basis of the time shift between reference oscillators 624 of the radio transceivers and a propagation delay time associated with the code transmission and reception, and acquires space-time difference information including the time difference information and the spatial difference information. The time difference information is the time error between the radio transceiver 62M and a radio transceiver 62S serving as a reference, and the spatial difference information is the spatial error between the current position and the proper position of the radio transceiver 62M relative to the radio transceiver 62S serving as the reference.

However, in the distributed SAR system 6 according to the present embodiment, the reference oscillator 624 of the radio transceiver 62M in the master SAR device 61M is selected as the master clock. In order to synchronize the reference oscillators 624 of the radio transceivers 62S in the first to M-th slave SAR devices 61S1 to 61Sm, a synchronization control unit 6233 controls the space-time difference information acquisition unit 6232 to perform phase shift detection using the reference oscillator 624 as the master clock. Thus, the space-time difference information acquisition unit 6232 of the radio transceiver 62M does not acquire time difference information, and only spatial difference information is stored in a space-time difference information storage unit 625. In a case where the spatial difference information regarding another radio transceiver 62S is to be detected on the basis of the flight position of the master SAR device 61M, the space-time difference information acquisition unit 6232 of the radio transceiver 62M will no longer detect spatial difference information either. Note that when space-time difference information is stored in the space-time difference information storage unit 625, a time stamp is also stored to clarify the storage timing.

The pulse transmission-reception unit 622 generates a frequency-modulated chirp signal using a chirp pulse generation unit 6221, and emits a pulsed signal from the communication antenna 621, which is driven to the proper radiation position by an antenna drive unit 6222. A reflected signal that is a signal reflected by an observation target is received by a reflected signal reception unit 6223 and is then stored in a reflected signal storage unit 626. In this case, a time stamp is also stored to clarify the storage timing of the reflected signal. reception data transmission unit 6271 then transmits reception data to the SAR signal processing device 63 of the mobile control device 64. The reception data are constituted by the reflected signal received by the pulse transmission-reception unit 622 and stored in the reflected signal storage unit 626, the space-time difference information stored in the space-time difference information storage unit 625, and the unique information regarding the radio transceiver 62M. Note that the correspondence relationship between the reflected signal and the space-time difference information can be determined by the SAR signal processing device 63 from the respective time stamps.

The radio transceivers 62S of the first to M-th slave SAR devices 61S1 to 61Sm also have substantially the same configurations as that of the radio transceiver 62M of the master SAR device 61M described above, and thus the same functions will be denoted by the same signs, description will be omitted, and only different points will be described below.

The space-time difference information acquisition unit 6232 of the radio transceiver 62S acquires time difference information using the reference oscillator 624 of the radio transceiver 62M as the master clock through wireless communication using the antenna 6231 for synchronization, and the synchronization control unit 6233 controls the reference oscillator 624 to correct the time error. As a result, the reference oscillator 624 of the radio transceiver 62S will be synchronized to the reference oscillator 624 of the radio transceiver 62M. Thus, the phases of the chirp pulses generated by the chirp pulse generation units 6221 of the radio transceivers 62S of the first to M-th slave SAR devices 61S1 to 61Sm can be aligned with high precision. That is, when pulse signals are simultaneously emitted from the master SAR device 61M and the first to M-th slave SAR devices 61S1 to 61Sm toward the observation area OA, the emitted pulse signals are treated as if high-power chirp pulses were emitted from a single apparent antenna. As a result, the reception levels of the reflected signals from the observation target become higher, and the effect of noise can be reduced. In addition, since the reflected signals from the observation object are simultaneously received by the master SAR device 61M and the first to M-th slave SAR devices 61S1 to 61Sm, the reflected signals are apparently received by a larger aperture antenna.

Note that the master SAR device 61M may have the control function in the distributed SAR system 6 (for example, flight speed control and directional control of the communication antenna 621), or the movement control unit 64 may have the control function.

The SAR signal processing device 63 of the mobile control device 64 acquires reception data from the master SAR device 61M and the first to M-th slave SAR devices 61S1 to 61Sm via an antenna 631 for data reception and a wireless communication unit 632. For the reflected signal in the reception data from the master SAR device 61M, a phase adjustment unit 633 performs phase adjustment to correct the spatial error based on the spatial difference information in the space-time difference information. This provides the reception data of the master SAR device 61M with the spatial error corrected on the basis of the space-time difference information. Similarly, for the reflected signals in the reception data from the first to M-th slave SAR devices 61S1 to 61Sm, the phase adjustment unit 633 performs phase adjustment to correct the spatial errors based on the spatial difference information in the space-time difference information. This provides the reception data of the first to M-th slave SAR devices 61S1 to 61Sm with the phase shifts corrected on the basis of the space-time difference information.

As described above, the reflected signals received simultaneously by the master SAR device 61M and the first to M-th slave SAR devices 61S1 to 61Sm can be treated as data from the same observation area OA. In a case where phase adjustment is performed on these simultaneously acquired reflected signals and these resulting signals are synthesized into synthetic reception data, the effect of irregular noise is reduced. Thus, in a case where a correlation processing execution unit 634 performs correlation processing on the synthetic reception data to perform resolving, it is possible to obtain a highly accurate two-dimensional image.

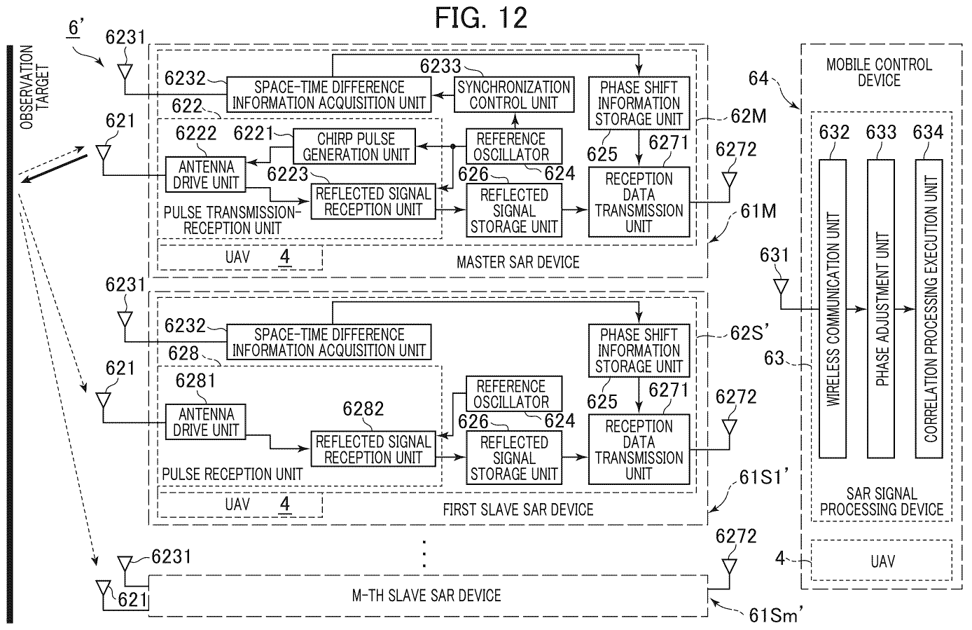

Note that as in a distributed SAR system 6′ illustrated in FIG. 12, only the master SAR device 61M emits chirp pulses, and radio transceivers 62S′ of first to M-th slave SAR devices 61S1′ to 61Sm′ may be configured to receive pulses only. In this case, each radio transceiver 62S′ does not have to have the function of synchronizing the reference oscillator 624 to the master clock, and it is sufficient that the pulse transmission function of the pulse transmission-reception unit 622 be not used. Alternatively, a pulse reception unit 628 may be provided instead of the pulse transmission-reception unit 622, and the pulse reception unit 628 may include only an antenna drive unit 6281 for driving the communication antenna 621 and a reflected signal reception unit 6282. Even in this distributed SAR system 6′, in a case where the reflected signals received simultaneously by the master SAR device 61M and the first to M-th slave SAR devices 61S1′ to 61Sm′ are synthesized and undergone correlation processing, a highly accurate two-dimensional image can be obtained.

The embodiments of the radio transceiver, distributed phased array antenna system, distributed electromagnetic wave observation data collection system, and distributed SAR system according to the present invention have been described above on the basis of the attached drawings; however, the present invention is not limited to these embodiments and may be implemented by using equivalent technical means that are known and existing to the extent that the configurations described in the claims are not changed.

### REFERENCE SIGNS LIST

1 distributed phased array antenna system
2 radio transceiver
21 communication antenna
24 phase adjustment unit
26 reference oscillator
28 space-time difference information acquisition unit

1. A radio transceiver, which is usable as an antenna element included in a phased array antenna system in which a plurality of the antenna elements is arranged in an array to obtain a desired directivity, the antenna element comprising:
N (N is any natural number) communication antennas; a space-time difference information acquisition unit; a phase shift adjustment unit; and a reference oscillator that generates a reference frequency signal, wherein
the space-time difference information acquisition unit transmits and receives codes to and from another radio transceiver in both ways through wireless communication using an antenna for synchronization different from the communication antennas, measures time difference information and spatial difference information based on a time shift between the reference oscillators of the radio transceivers and a propagation delay time associated with the code transmission and reception, and acquires space-time difference information including the time difference information and the spatial difference information, wherein the time difference information is a time error between the radio transceiver serving as a reference and the radio transceiver, and the spatial difference information is a spatial error between a current position of the radio transceiver and a proper position of the radio transceiver relative to the radio transceiver serving as the reference, and
the phase shift adjustment unit adjusts, based on the space-time difference information, a phase shift amount of radio waves radiated from the communication antennas to correct the time error, the spatial error, or both the time and spatial errors.

2. A distributed phased array antenna system consisting the phased array antenna system that includes a plurality of the radio transceivers according to Claim 1 and has a specific directivity obtained by superimposing radio waves radiated from the communication antennas of each radio transceiver.

3. A radio transceiver, which is usable as an antenna element included in a beamforming antenna in which a plurality of the antenna elements is arranged in an array and that is capable of forming reception beams with various directivities by synthesizing reception signals, which are received by the respective antenna elements, through appropriate phase shift processing and appropriate weighting (amplitude amplification and attenuation) processing, the radio transceiver comprising:
N (N is any natural number) communication antennas; a space-time difference information acquisition unit; N signal reception units corresponding to the respective communication antennas; a reception data transmission unit; and
a reference oscillator that generates a reference frequency signal, wherein
the space-time difference information acquisition unit transmits and receives codes to and from another radio transceiver in both ways through wireless communication using an antenna for synchronization different from the communication antennas, measures time difference information and spatial difference information based on a time shift between the reference oscillators of the radio transceivers and a propagation delay time associated with the code transmission and reception, and acquires space-time difference information including the time difference information and the spatial difference information, wherein the time difference information is a time error between the radio transceiver serving as a reference and the radio transceiver, and the spatial difference information is a current relative position of the radio transceiver to the radio transceiver serving as the reference, and
the reception data transmission unit transmits, outside the radio transceiver, reception data in which reception signals received by the signal reception units, the space-time difference information at reception timings of the reception signals, and unique information regarding the radio transceiver set to allow identification between the radio transceiver and the other radio transceiver are associated with each other.

4. A distributed electromagnetic wave observation data collection system comprising:
a plurality of slave mobility devices that is obtained by mounting the radio transceivers according to claim 3 on mobile units; and
a master mobility device that is obtained by mounting a data relay on a mobile unit, the data relay at least collecting reception data transmitted from the plurality of slave mobility devices and transferring the collected reception data collectively to a predetermined data collection center, wherein
the plurality of slave mobility devices and the master mobility device are arranged in an electromagnetic wave observation area that is set freely, only the master mobility device that has collected the reception data from each slave mobility device transfers the collected reception data as electromagnetic wave observation data to the data collection center.

5. A radio transceiver, which is usable as an antenna element included in a synthetic aperture radar in which a plurality of the antenna elements is arranged in an array and that is capable of generating a two-dimensional image by causing a synthetic aperture radar signal processing device to process reception signals obtained by repeatedly transmitting and receiving a pulse while moving over an image acquisition area in an azimuth direction, the radio transceiver comprising:
N (N is any natural number) communication antennas; N pulse transmission reception units corresponding to the respective communication antennas; a space-time difference information acquisition unit; a reception data transmission unit; and a reference oscillator that generates a reference frequency signal, wherein
the space-time difference information acquisition unit transmits and receives codes to and from another radio transceiver in both ways through wireless communication using an antenna for synchronization different from the communication antennas, measures time difference information and spatial difference information based on a time shift between the reference oscillators of the radio transceivers and a propagation delay time associated with the code transmission and reception, and acquires space-time difference information including the time difference information and the spatial difference information, wherein the time difference information is a time error between the radio transceiver serving as a reference and the radio transceiver, and the spatial difference information is a spatial error between a current position of the radio transceiver and a proper position of the radio transceiver relative to the radio transceiver serving as the reference, and
the reception data transmission unit transmits, as reception data, reflected signals received by the pulse transmission reception units, the space-time difference information acquired by the space-time difference information acquisition unit, and unique information regarding the radio transceiver set to allow identification between the radio transceiver and the other radio transceiver to the synthetic aperture radar signal processing device.

6. A distributed synthetic aperture radar system comprising:
a master synthetic aperture radar device that is obtained by mounting the radio transceiver according to claim 5 on a mobile unit and that transmits a pulse signal to the image acquisition area and receives a reflected signal;
M (M is any natural number) slave synthetic aperture radar devices that are obtained by mounting the radio transceivers according to claim 5 on mobile units and that transmit pulse signals to the same image acquisition area as the master synthetic aperture radar device and receive reflected signals; and
a synthetic aperture radar signal processing device that generates a two-dimensional image by processing reception data from the master synthetic aperture radar device and the slave synthetic aperture radar devices, wherein
the slave synthetic aperture radar devices acquire the space-time difference information using the master synthetic aperture radar device as the radio transceiver serving as a reference, and transmit pulse signals in synchronization with pulse transmission of the master synthetic aperture radar device by performing phase adjustment to correct the time errors based at least on the time difference information, and
the synthetic aperture radar signal processing device performs phase adjustment to correct, based at least on the spatial difference information in the space-time difference information, the spatial error regarding the reflected signals in the reception data from the master synthetic aperture radar device, the slave synthetic aperture radar devices, or both the master and slave synthetic aperture radar devices.
